(19) United States
(12) Patent Application Publication
(10) Pub. No.: US 2026/0034929 A1
(43) Pub. Date: Feb. 5, 2026

(54) AUTONOMOUS VEHICLE

(71) Applicant: Ocado Innovation Limited, Hatfield (GB)

(72) Inventor: Maurice Roland Capitulo Ampane, Quincy, MA (US)

(21) Appl. No.: 18/793,310

(22) Filed: Aug. 2, 2024

(51) Int. Cl. B60Q 1/50; B60W 60/00

(52) U.S. Cl. CPC B60Q 1/507; B60W 60/001; B60W 2554/40

(57) ABSTRACT

There is disclosed an autonomous vehicle for use in a storage environment, such as a warehouse for example. Reflective material may be applied to the faces of the autonomous vehicle such that the sensors of other autonomous vehicles are able to differentiate an autonomous vehicle from other objects in the storage environment. Appropriate patterning of the reflective material, which may be a retroreflective material, enables the identity of an autonomous vehicle to be determined. Furthermore, the position, orientation, and direction of movement of the autonomous vehicle may be determined.

### TECHNICAL FIELD

The present disclosure relates to an autonomous vehicle, and in particular to an autonomous vehicle comprising reflective elements.

### BACKGROUND

It is well known for autonomous vehicles to be used in storage environments such as, for example, warehouses. Such autonomous vehicles may be used in different processes within a warehouse, for example: transporting pallets or cases of product from a loading bay; transporting cases or containers of product to storage locations within the warehouse; picking products as part of picking one or more orders; transporting picked orders to a packing station; transporting packed orders to a dispatch station, etc. It is conventional for such autonomous vehicles to comprise optical sensors to detect other items and structures which will be present in the warehouse, for example other autonomous vehicles, warehouse workers, stacks of pallets, shelving, etc., such that collisions can be avoided and that the autonomous vehicles can safely and efficiently determine and follow a route from a start location to destination location within the warehouse.

According to a first aspect of the present disclosure there is provided an autonomous vehicle comprising one or more regions of reflective material applied to one or more faces of the autonomous vehicle. The reflective material may be a retroreflective material.

The light signals that are detected by an autonomous vehicle, for example from a lidar sensor, enable further autonomous vehicles to be differentiated from other objects present in a warehouse, or other environment.

Each face of the autonomous vehicle may comprise one or more regions of reflective material. The reflective material may extend along substantially the whole face of the autonomous vehicle. The one or more regions of reflective material may comprise one or more regions of low reflectivity reflective material and/or one or more regions of high reflectivity reflective material.

The one or more regions of reflective material applied to one of the faces of the autonomous vehicle may comprise a pattern. The pattern of reflective material applied to one of the faces of the autonomous vehicle differs from the pattern of reflective material applied to the other faces of the autonomous vehicle.

By applying different patterns to different faces of an autonomous vehicle then it is possible to determine the orientation of an autonomous vehicle. Further observation of the autonomous vehicle enables the direction of movement of the autonomous vehicle to be determined. This information can be used in the planning of a route by one or more further autonomous vehicles.

If the patterning is unique to a particular autonomous vehicle, then it is possible for the identity of the autonomous vehicle to be determined.

The autonomous vehicle may further comprise one or more light sources, the autonomous vehicle being configured to detect reflected light signals and to identify one or more further autonomous vehicles in accordance with the detected light signals.

According to a second aspect of the present disclosure there is provided a method of operating an autonomous vehicle, the autonomous vehicle comprising one or more light sources, one or more light detectors and one or more regions of reflective material, the method comprising: emitting light from the one or more light sources; detecting light received at the one or more light detectors; and identifying one or more further autonomous vehicles in accordance with the detected light. One or more of the position, orientation, type, speed, and/or direction of the one or more further autonomous vehicles may be determined in accordance with the detected light.

### BRIEF DESCRIPTION OF THE DRAWINGS

Examples of the disclosure will now be described by way of example only with reference to the accompanying drawings, in which like reference numbers designate the same or corresponding parts, and in which:

FIG. 1 shows a schematic depiction of a warehouse;

FIG. 2 shows a schematic depiction of an autonomous vehicle;

FIG. 3 shows a schematic depiction of an autonomous vehicle according to the present disclosure; and

FIG. 4 shows a schematic view of an example of patterns of retroreflective materials that are applied to the four different faces of an autonomous vehicle.

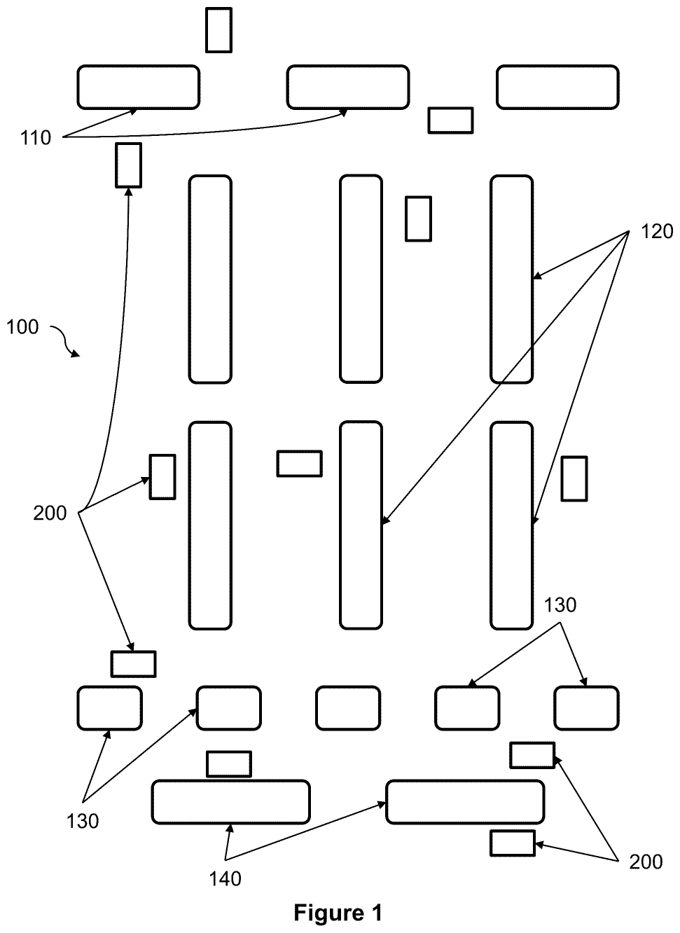

FIG. 1 shows a schematic depiction of a warehouse 100 which comprises one or more induct stations 110, a plurality of storage units 120, one or more packing stations 130 and one or more dispatch stations 140. Product items will be brought to an induct station, the product items being stored within a box, a case, on a pallet etc. according to the product item characteristics (for example product item type, weight, size, etc.). The product items will then be stored at a storage location within one of the storage units 120. The product items may be stored directly on a shelf within one of the storage units 120 or one or more product items may be placed into a container which is then stored at a storage location within one of the storage units 120. When a customer order is received for one or more product items then the ordered product items may be picked from the respective storage location(s) and then taken to a packing station 130 where the item(s) can be packed into an envelope (or other appropriate packaging). A number of packed orders can then be moved to a dispatch station 140 from where the packed orders can be grouped such that they can be delivered or sent to a further organisation for delivery. The warehouse further comprises a plurality of autonomous vehicles 200, often referred to as robotic vehicles or robots, which are used in some or all of the tasks carried out within the warehouse. The autonomous vehicles will need to co-operate with other autonomous vehicles and/or human operators. The autonomous vehicles will receive instructions and/or information from a warehouse management system.

In the course of executing the instructions received from the warehouse management system, an autonomous vehicle will need to navigate to a specified destination and will need to avoid the fixed structures of the warehouse as well as the other autonomous vehicles and the human operators which are active in the warehouse. The warehouse may deploy a single type of bot. Alternatively, a mixed fleet comprising two or more different types of bots may be deployed, for example because the different types of bots have different capabilities or characteristics.

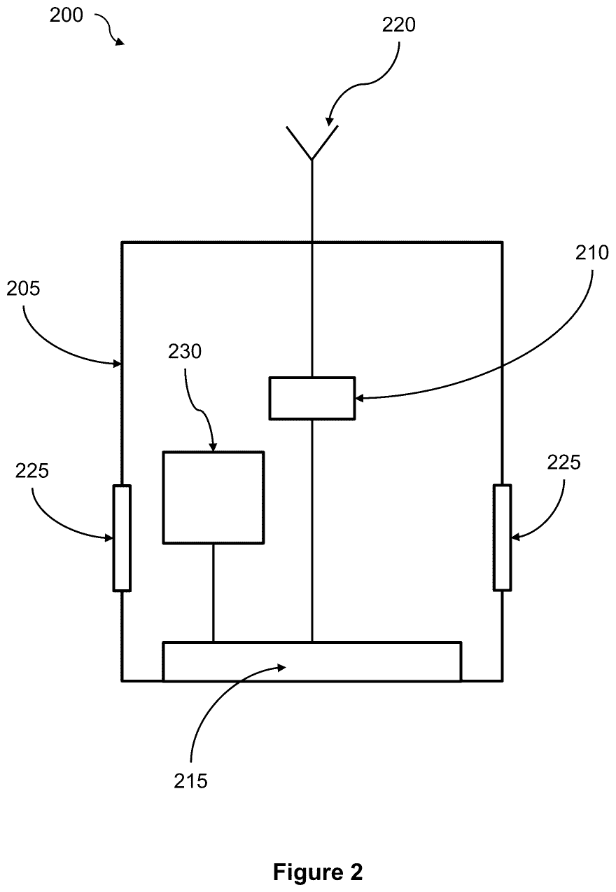

FIG. 2 shows a schematic depiction of an autonomous vehicle 200 which comprises a body 205, control circuitry 210, drive unit 215, wireless network interface 220, one or more sensors 225 and power source 230. In use, the control circuitry 210 receives information from the warehouse management system via the wireless network interface 220. The wireless network interface 220 may be a WiFi interface or an LTE-based interface. The control circuitry controls the drive unit 215 to determine the movement of the autonomous vehicle. The drive unit 215 may comprise one or more wheels (or rollers) and one or more motors to activate the one or more wheels (or rollers). The power source 230 provides power to the drive unit. In one example, the power source 230 comprises one or more batteries which provide electrical power to the drive unit. The control circuitry 210 may store a map of the warehouse such that the location and size of fixed structures in the warehouse are known by the autonomous vehicle. The one or more sensors 225 are used to detect both fixed structures and moving objects within the warehouse, for example human operators, other autonomous vehicles, other movable items such as hand carts or trolleys etc.

The one or more sensors may comprise one or more lidar (light detection and ranging) sensors. The lidar sensor data may take the form of a two dimensional array. Lidar sensors measure the time that a transmitted signal takes to be reflected back to the sensor. This data can then be used to calculate the distance between the lidar sensor and the surface from which the light is reflected. It should be understood that an autonomous vehicle may comprise one or more further sensors in addition to the lidar sensors. These further sensors may comprise one or more optical sensors, one or more ultrasonic sensors and/or other types of sensors. The control circuitry can use the information generated by the one or more sensors to move the autonomous vehicle within the warehouse without colliding with another autonomous vehicle or other object. An exemplary autonomous vehicle of a first type is disclosed in U.S. Pat. No. 10,053,289, the contents of which are hereby incorporated by reference. A further type of an exemplary autonomous vehicle, which is capable of lifting and moving pallets, is disclosed in international patent application PCT/EP2024/054402, the contents of which are hereby incorporated by reference.

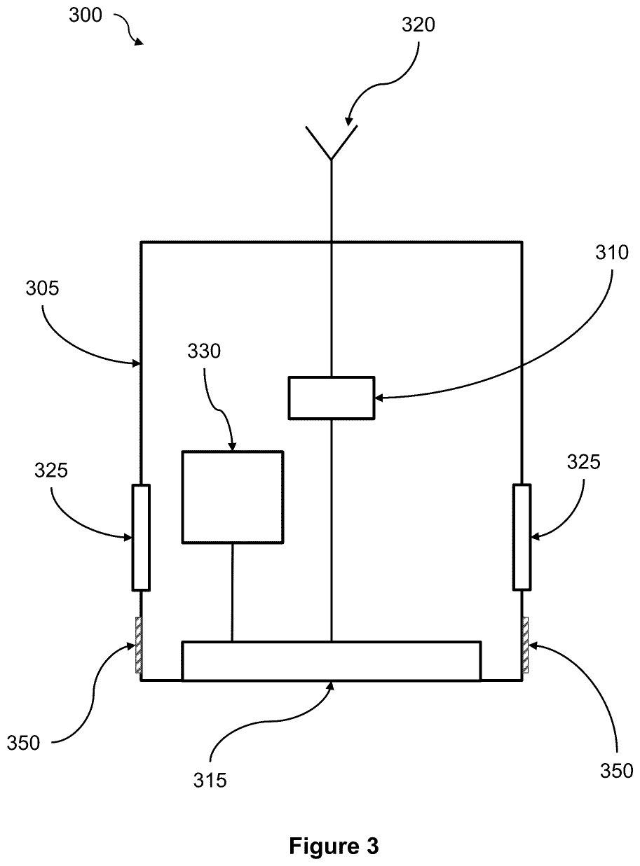

FIG. 3 shows a schematic depiction of an autonomous vehicle 300 according to the present disclosure. The autonomous vehicle 300 comprises a body 305, control circuitry 310, drive unit 315, wireless network interface 320, one or more sensors 325 and power source 330, as discussed above with reference to the autonomous vehicle 200 shown in FIG. 2. The autonomous vehicle 300 further comprises reflective material 350 placed on parts of one or more faces of the body of the autonomous vehicle 300. Thus, the reflective material 350 will reflect more light back than the other regions of the body of the autonomous vehicle (henceforth bot).

In one alternative, the reflective material 350 may comprise a retroreflective material. A retroreflective material will reflect incident light back to its source and thus any light emitted by a lidar sensor will reflect back to the sensor. Thus, a lidar signal generated by a first bot will reflect back to the lidar sensor from the retroreflective material placed on a face of a second bot. The light will reflect back to the sensor regardless of the angle of incidence of the transmitted lidar signal on the second bot. The signal reflected by the retroreflective material will be stronger than that reflected by the other regions of the body of the bot. This variation in reflected signal strength can be used in interpreting the lidar sensor data, as it can be determined that the reflection is caused by another bot, and not a storage location or other structure.

In a further alternative, retroreflective material can be placed on each face of the bot. In one example, a retroreflective material may be placed on each face of the bot to form a pattern. The pattern may be formed by leaving gaps between regions of retroreflective material, as the material that forms the body of the bot will not be retroreflective. In an alternative arrangement, regions of high reflectivity retroreflective material may be arranged next to regions of low reflectivity retroreflective material. The difference in reflected signals from the regions of different materials can be more easily detected by the lidar sensors. By having retroreflective material placed on each face of a bot then it is possible for a first bot to identify a second bot in a warehouse and to distinguish it from other items or structures which are present in the warehouse.

In a further arrangement, the pattern formed on each face of the bot may be different. That is, the pattern on the front face of the bot is different from the pattern on the rear face, the left face, and the right face of the bot. The use of four different patterns enables a first bot to identify the face (or faces) of a second bot which are illuminated by a lidar sensor of the first bot. By identifying the nearest face (or faces) of the second bot then it is possible to determine the orientation of the second bot relative to the first bot. If the first bot is moving relative to the second bot, then the change in the position and/or the orientation of the second bot relative to the first bot may be determined and updated in accordance with the relative movement of the bots. The control circuitry first bot may decide to modify the route of the first bot to reduce the possibility of a collision with the second bot.

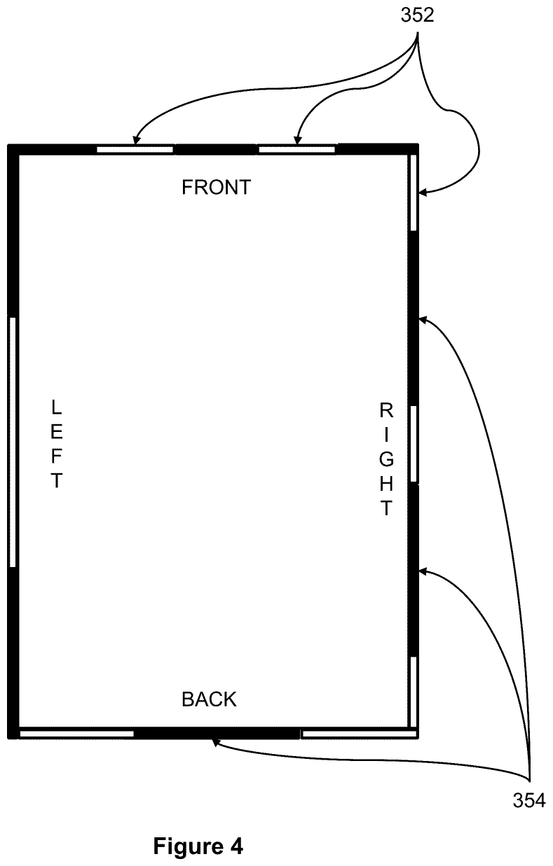

FIG. 4 shows a schematic view of an example of patterns of retroreflective materials that are applied to the four different faces of a bot. The sections of retroreflective material 352 are interspersed with uncovered regions 354 of the body of the bot which are not retroreflective and which have a low reflectivity. The result of this is that the lidar sensor detects a relatively high intensity from the segments of retroreflective material 352 and a relatively low intensity from the uncovered regions of the bot. The variations in the number of sections of retroreflective material and uncovered regions of the body of the bot and the length of those sections enable each of the four faces to be differentiated from each other, such that the orientation and the position of a bot can be determined based on the reflected light signals detected by a lidar sensor.

In a further example, in a warehouse where a mixed fleet of bots have been deployed then each type of bot may have a different set of patterns of reflective material applied to the bots. Thus, the type of bot may also be identified based on the reflected light signals detected by a lidar sensor.

In a yet further example, each individual bot deployed in a warehouse may be provided with a unique pattern of reflective material applied to the bot. In such a case, this enables a first bot to determine the identity, location, orientation, and direction of movement of the other bots which are detected by the lidar sensors of the first bot. This information may then be used by the first bot to modify its planned route to reduce the possibility of a collision with the other bot(s).

It will be understood that the retroreflective material may be applied to form a linear, one-dimensional pattern. In an alternative, more complex two-dimensional patterns may be formed but it should be understood that the size of the elements of such patterns will be limited by the spatial resolution of the lidar scanners used.

The retroreflective material may take the form of a tape. An example of a suitable retroreflective tape is the reflective floor marking tape available from McMaster-Carr (at https://www.mcmaster.com/5997T88/). it should be understood that other retroreflective tapes or materials may also be placed on the face of a bot.

This data, relating to the identity, location, orientation, and direction of movement of other bots, can also be transmitted to the warehouse management system. The warehouse management system can combine such data received from all of the bots active in the warehouse to update a map of the warehouse so as to include the location and orientation of each of the bots. Such information can be used to locate bots within the warehouse or can be used in conjunction with other techniques used to locate the bots, for example based on the information obtained from the wireless network used by the warehouse management system to communicate with the bots.

The data held in this map of the deployed bots may then be transmitted by the warehouse management system to each of the bots, such that each active bot is aware of the identity, location & orientation of all of the other bots. In some cases, it may be more efficient to subdivide the map into a plurality of regions and to only transmit one or more map regions to each active bot such that each bot receives information relevant to those bots which are relatively near to it.

In one respect, there is disclosed an autonomous vehicle for use in a storage environment, such as a warehouse for example. Reflective material may be applied to the faces of the autonomous vehicle such that the sensors of other autonomous vehicles are able to differentiate an autonomous vehicle from other objects in the storage environment. Appropriate patterning of the reflective material, which may be a retroreflective material, enables the identity of an autonomous vehicle to be determined. Furthermore, the position, orientation, and direction of movement of the autonomous vehicle may be determined.

1. An autonomous vehicle comprising one or more regions of reflective material applied to one or more faces of the autonomous vehicle.

2. An autonomous vehicle according to claim 1, where each face of the autonomous vehicle comprises one or more regions of reflective material.

3. An autonomous vehicle according to claim 1, wherein the reflective material extends along substantially the whole face of the autonomous vehicle.

4. An autonomous vehicle according to claim 1, wherein the one or more regions of reflective material comprise one or more regions of low reflectivity reflective material and/or one or more regions of high reflectivity reflective material.

5. An autonomous vehicle according to claim 1, wherein the one or more regions of reflective material applied to one of the faces of the autonomous vehicle comprise a pattern.

6. An autonomous vehicle according to claim 5, wherein the pattern of reflective material applied to one of the faces of the autonomous vehicle differs from the pattern of reflective material applied to the other faces of the autonomous vehicle.

7. An autonomous vehicle according to claim 1, wherein the reflective material is a retroreflective material.

8. An autonomous vehicle according to claim 1, the autonomous vehicle comprising one or more light sources, the autonomous vehicle being configured to detect reflected light signals and to identify one or more further autonomous vehicles in accordance with the detected reflected light signals.

9. A method of operating an autonomous vehicle, the autonomous vehicle comprising one or more light sources, one or more light detectors and one or more regions of reflective material, the method comprising:
emitting light from the one or more light sources;
detecting light received at the one or more light detectors; and
identifying one or more further autonomous vehicles in accordance with the detected light.

10. A method according to claim 9, wherein a position of the one or more further autonomous vehicles is identified.

11. A method according to claim 9, wherein an orientation of the one or more further autonomous vehicles is identified.

12. A method according to claim 9, wherein a type of the one or more further autonomous vehicles is identified.

13. A method according to claim 9, wherein a speed or direction of movement of the one or more further autonomous vehicles is determined in accordance with the detected light.
